(19) United States
(12) Patent Application Publication
(10) Pub. No.: US 2011/0002237 A1
(43) Pub. Date: Jan. 6, 2011

(54) WIRELESS COMMUNICATION SYSTEM, TRANSMISSION APPARATUS AND COMMUNICATION CONTROL METHOD

(75) Inventor: Taku Nakayama, Yokohama-shi (JP)

Correspondence Address: OLIFF & BERRIDGE, PLC, P.O. BOX 320850, ALEXANDRIA, VA, 22320-4850, US

(73) Assignee: KYOCERA CORPORATION, Kyoto (JP)

(21) Appl. No.: 12/919,338

(22) PCT Filed: Feb. 25, 2009
(86) PCT No.: PCT/JP2009/053364

§ 371 Date: Aug. 25, 2010

(30) Foreign Application Priority Data
Feb. 27, 2008 (JP) 2008-045870

(51) Int. Cl. H04L 12/26; H04W 4/00

(52) U.S. Cl. 370/252; 370/328

(57) ABSTRACT

Provided is a transmission device comprising a transmission weight generating unit for generating a plurality of transmission weights, a communication quality acquiring unit for acquiring a value indicating the communication quality of each of unique paths, and a transmission weight determining unit for selecting such one of the transmission weights generated by the transmission weight generating unit that the difference of the values indicating the communication qualities acquired by the communication quality acquiring unit between the individual unique paths is at or lower than a predetermined value and that the sum of all the communication qualities of the unique paths becomes the maximum.

### CROSS REFERENCE TO RELATED APPLICATION

This application claims priority to and the benefit of Japanese Patent Application No. 2008-45870 (filed on Feb. 27, 2008), the entire content of which is incorporated herein by reference.

### TECHNICAL FIELD

The present invention relates to wireless communication systems, transmission apparatuses and communication control methods for performing MIMO communication by using a plurality of antennas both at a transmission side and at a reception side.

### BACKGROUND ART

In recent years, MIMO (Multi-Input Multi-Output) transmission technology has been put into practical use for a communication system. For the MIMO transmission, both apparatuses at the transmission side and at the reception side use a plurality of antennas, so as to improve a transmission speed and reliability. It is also known that characteristics of MIMO may be further improved by configuring the system such that the apparatus at the reception side feeds back channel information obtained to the apparatus at the transmission side and the apparatus at the transmission side uses the information. This is referred to as closed loop MIMO or feedback MIMO.

Characteristics are improved as the information to be fed back is more detailed. This requires, however, a large amount of feedback information, which leads to tight system capacity.

In order to solve such a problem, it is possible to reduce the amount of feedback information dramatically by preparing a plurality of common transmission weights for both apparatuses at the transmission side and at the reception side in advance and configuring the apparatus at the reception side to designate an index of transmission weight desired to be used at transmission.

At this time, the transmission weight is selected based on MIMO (SVD-MIMO) using singular value decomposition, and the apparatus at the reception side measures channel information and selects a transmission weight which maximizes a sum of SINR (Signal to Noise plus Interference Ratio) of all eigenpaths when the channel information and the transmission weight are combined.

FIG. 8 is a flowchart illustrating a conventional method to select a transmission weight. According to the conventional method, first, candidates for the transmission weight are generated (step 201). Next, it is determined whether calculation of SINR of eigenpaths for all of the candidates for the transmission weight is finished (step 202). If the calculation is not finished (if No), SINR of each eigenpath is calculated for a current candidate for the transmission weight (step 203). Next, it is determined whether the sum of SINR of all eigenpaths exceeds a maximum value of the sum of SINR previously calculated (step 204). If exceeding (if Yes), the current candidate for the transmission weight and the sum of SINR are stored (step 205). If not exceeding (if No), it is once again determined whether the calculation of SINR of the eigenpaths for all of the candidates for the transmission weight is finished (step 202). If the calculation for all of the candidates for the transmission weigh is finished (if Yes), the candidate for the transmission weight stored is output (step 206).

### Patent Document 1: Japanese Unexamined Patent Application Publication No. 2005-522086

### DISCLOSURE OF THE INVENTION

### Problems to be Solved by the Invention

Although the characteristics of MIMO are improved by the conventional method to select a transmission weight, MIMO using the singular value decomposition generates significant difference in quality among eigenpaths. It is known, in such a case, to dramatically improve the overall characteristics by selecting a modulation scheme suitable for each eigenpath or performing a suitable correction processing. However, it is difficult to perform adaptive control for each eigenpath when employing a MIMO scheme, such as SCW (Single Code Word) scheme which is one of operation modes of MIMO, which modulates data in a single packet in a lump and performs the correction processing.

In such a case, there has been a problem that an entire packet becomes error because of error occurred in any one of the eigenpaths although the sum of SINR of all eigenpaths is the maximum.

In order to address such problems, an object of the present invention is to provide wireless communication systems, transmission apparatuses and communication control methods capable of taking advantages of MIMO fully, even if employing the SCW scheme, by selecting a transmission weight such that respective qualities of the plurality of eigenpaths become equivalent as much as possible and the overall communication quality of the eigenpaths is increased, at selection of the transmission weight.

### SUMMARY OF THE INVENTION

In order to achieve the above object, the present invention is characterized in a wireless communication system for performing wireless communication via a plurality of paths between a transmission apparatus and a reception apparatus, including: a transmission weight generation unit for generating a plurality of transmission weights; a communication quality obtain unit for obtaining a value indicating communication quality of each of the paths; and a transmission weight determination unit for selecting a transmission weight, among the transmission weights generated by the transmission weight generation unit, such that difference in the values indicating the communication qualities of the paths obtained by the communication quality obtain unit is equal to or less than a predetermined value and a sum of all communication qualities of the plurality of paths is maximized.

It is preferred that selecting the transmission weight is performed when the transmission apparatus transmits a single packet by dividing it into the plurality of paths, and that the packet is a packet passed through modulation and coding process.

In addition, the present invention is characterized in a transmission apparatus for performing wireless communication via a plurality of paths, the transmission apparatus applying a transmission weight such that difference in values indicating communication qualities of the paths is equal to or less than a predetermined value and a sum of all communication qualities of the plurality of paths is maximized when performing transmission via the plurality of paths.

The present invention is characterized in a communication control method of a wireless communication system for performing wireless communication via a plurality of paths between a transmission apparatus and a reception apparatus, including the steps of: generating a plurality of transmission weights; obtaining a value indicating communication quality of each of the paths; and selecting a transmission weight, among the transmission weights generated, such that difference in the values indicating the communication qualities of the paths is equal to or less than a predetermined value and a sum of all communication qualities of the plurality of paths is maximized.

### EFFECT OF THE INVENTION

According to the present invention, it is possible to take advantages of MIMO fully, even if employing the SCW scheme, by selecting a transmission weight such that respective qualities of the plurality of eigenpaths become equivalent as much as possible, and the overall communication quality of the eigenpaths is increased, at selection of the transmission weight.

### BRIEF DESCRIPTION OF DRAWINGS

FIG. 1 is a graph showing BER characteristics of a conventional system;

FIG. 2 is a basic configuration diagram illustrating a wireless communication system according to the present invention;

FIG. 3 is a configuration diagram illustrating a transmission weight selection unit;

FIG. 4 is a flowchart illustrating an operation to select the transmission weight according to the present invention;

FIG. 5 is a graph showing BER characteristics of the wireless communication system according to the present invention;

FIG. 6 is a graph showing the BER characteristics of the conventional system and the wireless communication system according to the present invention;

FIG. 7 is a graph showing the number of bits which can be transmitted per symbol; and

FIG. 8 is flowchart illustrating a conventional operation to select the transmission weight.

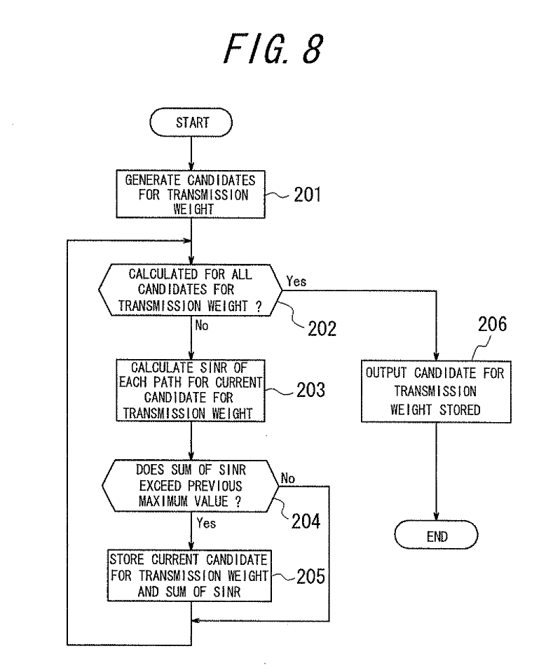

### DESCRIPTION OF EMBODIMENT

The following is a detailed description of embodiments of the present invention. A transmission weight is defined by the following formula, for example.

$${H}_{M}^{( g )} = \frac{1}{\sqrt{M}} [ {h}_{nm}^{( g )} ] = \frac{1}{\sqrt{M}} [ {e}^{\{ j \frac{2 π n}{M} ( m + \frac{g}{G} ) \}} ] \qquad [ Formula 1 ]$$

From the formula above, a method to calculate SINR as a reference for selecting the transmission weight is described.

Provided that the number of transmission antennas is N, the number of reception antennas is M, the number of used eigenpaths is R, a transmission signal is x (x is a complex vector of R-dimension) and a reception signal is y (y is a complex vector of the R-dimension), a propagation path H (H is a complex matrix of M×N dimension), a transmission weight (Precoding Matrix) W_{Tx} (W_{Tx} is a complex matrix of N×R dimension), a reception weight matrix W_{Rx} (W_{Rx} is a complex matrix of R×M dimension) and a noise power N (N is a complex diagonal matrix of M×M dimension) satisfy the following formula:

y=W_{Rx}(HW_{Tx}x+N) [Formula 2]

Provided that a reception scheme is MMSE (Minimum Mean Square Error), the reception weight W_{Rx} can be expressed as following formula:

W={(Hw_{Tx})^{H}(HW_{Tx})+SNR}⁻¹(HW_{Tx})^{H} [Formula 3]

That is, the reception weight W_{Rx} is derived from the propagation path H and the transmission weight (Precoding Matrix) W_{Tx}.

The reception weight W_{Rx} for all of the transmission weight (Precoding Matrix) W_{Tx} generated is calculated and substituted into W_{Rx}HW_{Tx}, so as to obtain all channel responses without the noise power between a transmission side and a reception side:

Hₐₗₗ=W_{Rx}HW_{Tx} (Hₐₗₗ is a complex square matrix of R×R dimension)

Provided that respective transmission power of eigenpaths is equal when transmission is performed over a plurality of eigenpaths, the square of an absolute value of a diagonal element in each row of the formula 5 corresponds to a value of signal power of each eigenpath, while the square of an absolute value of a non-diagonal element corresponds to a value of interference power.

$${H}_{all} = [ \begin{matrix}{h}_{11} & {h}_{12} & ⋯ & {h}_{1 R} \\ {h}_{21} & {h}_{22} & & {h}_{2 R} \\ ⋮ & & ⋱ & ⋮ \\ {h}_{R 1} & {h}_{R 2} & ⋯ & {h}_{RR}\end{matrix} ] \qquad [ Formula 5 ]$$

In formula 6, even if the reception weight W_{Rx} is normalized such that norm of each row is 1, it has no influence on a ratio of the signal power and the interference power. Accordingly, it is possible to obtain normalized signal power and interference power to the noise power, by normalizing each row of the reception weight W_{Rx}.

Hₐₗₗ=W_{Rx}HW_{Tx} [Formula 6]

Thereby, it is possible to obtain SINR (Signal to Noise plus Interference Ratio) of each eigenpath when a given transmission weight is used. The transmission weight (Precoding Matrix) is selected based on SINR.

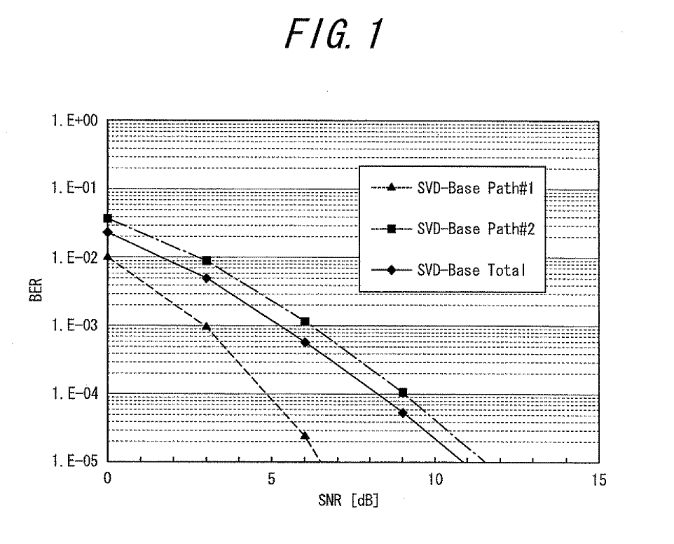

A conventional system selects a transmission weight (Precoding Matrix) which maximizes a sum of respective SINR of eigenpaths obtained. At this time, when a transmission weight (Precoding Matrix) which arranges the respective SINR of eigenpaths in descending order is selected, it is possible to obtain characteristics basically closest to SVD-MIMO. FIG. 1 shows BER (Bit Error Rate) characteristics of each eigenpath and overall BER characteristics at this time. FIG. 1 shows BER to SNR with 4 transmission antennas, 4 reception antennas, 2 eigenpaths, QPSK (primary modulation) and 5 GHz (transmission frequency).

Since the differences in characteristics of eigenpaths is large in the conventional system, some eigenpaths do not cause errors, while others cause errors. When employing a modulation scheme such as SCW, which uses a common modulation scheme to a single packet over a plurality of eigenpaths, it may be preferred to have less difference among eigenpaths so as to prevent errors in all of the eigenpaths.

In contrast to the conventional system described above, a wireless communication system according to the present invention, for the closed loop MIMO communication, selects a transmission weight such that communication qualities of the plurality of eigenpaths become equivalent as much as possible and the overall communication quality of eigenpaths is increased. Specifically, the wireless communication system according to the present invention selects a transmission weight (Precoding Matrix) which maximizes the sum of SINR of the eigenpath among all transmission weights (Precoding Matrix) with the difference in SINR of the eigenpaths equal to or less than a predetermined value.

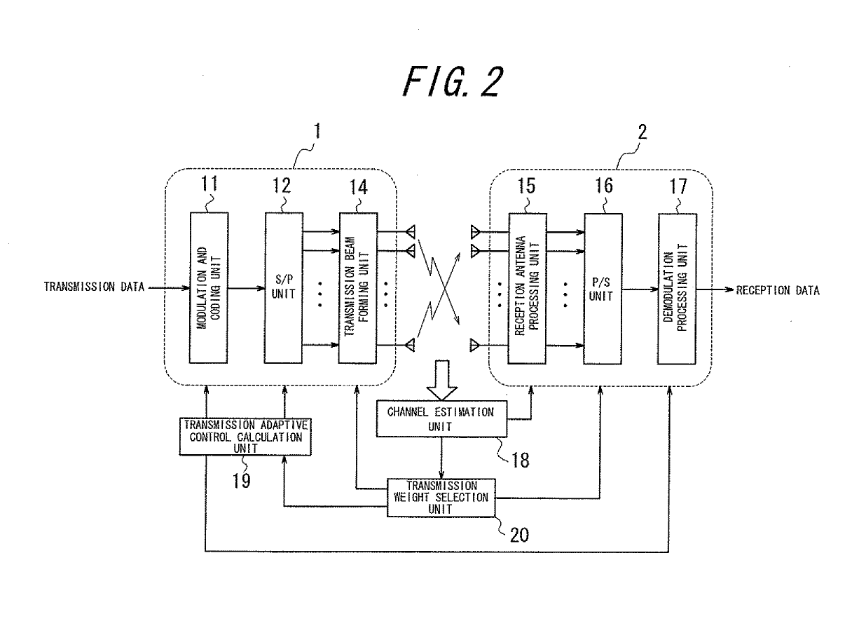

FIG. 2 is a basic configuration diagram of the wireless communication system according to the present invention. The wireless communication system according to the present invention transmits a single packet by dividing it into the plurality of eigenpaths by the MIMO scheme referred to as SCW. As shown in FIG. 2, a transmission apparatus 1 has a plurality of transmission antennas and is provided with a modulation and coding unit 11, an S/P unit 12 and a transmission beam forming unit 14. A reception unit 2 also has a plurality of reception antennas and is provided with a reception antenna processing unit 15, a P/S unit 16 and a demodulation processing unit 17. A channel estimation unit 18, a transmission adaptive control calculation unit 19 and a transmission weight selection unit 20 may be provided to either the transmission apparatus 1 or the reception apparatus 2.

The modulation and coding unit 11 modulates and encodes transmission data based on output of the transmission adaptive control calculation unit 19. The S/P unit 12 performs serial-to-parallel conversion on transmission data output by the modulation and coding unit 11 and outputs the transmission data for each eigenpath. The transmission beam forming unit 14 forms a transmission eigenbeam by applying the transmission weight output from the transmission weight selection unit 20 to a transmission signal of each eigenpath output by the S/P unit 12, and multiplexes the signal for each antenna.

A MIMO channel is formed between the plurality of transmission antennas and the plurality of reception antennas. The reception antenna processing 15 performs spatial filtering by calculating a reception weight based on a result of channel estimation output from the channel estimation unit 18, or extracts a signal of each eigenpath by performing a maximum likelihood reception process. The P/S unit 16 performs the parallel-to-serial conversion on reception data of each eigenmode. The demodulation processing unit 17 performs error-correction demodulation and the likes on the signal of each eigenmode and outputs the reception data.

Based on the signal received by the plurality of reception antennas, the channel estimation unit 18 estimates characteristics of the propagation path (channel estimation). The transmission adaptive control calculation unit 19 controls modulation and coding based on a value calculated by the transmission weight selection unit 20.

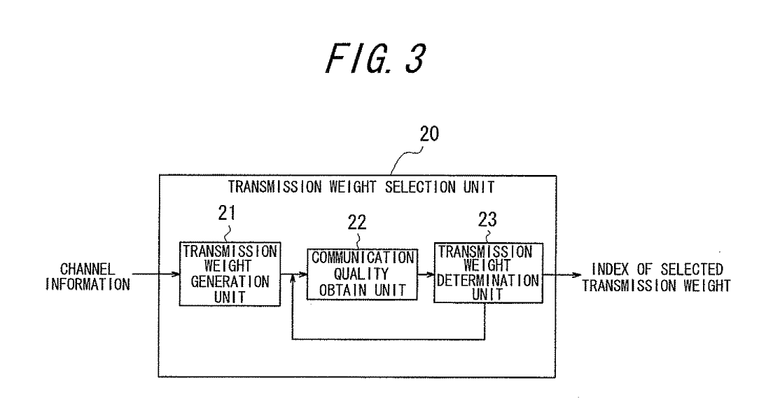

FIG. 3 is a configuration diagram of the transmission weight selection unit. The transmission weight selection unit 20 is provided with a transmission weight generation unit 21, a communication quality obtain unit 22 and a transmission weight determination unit 23. The transmission weight generation unit 21 generates a plurality of transmission weights. The communication quality obtain unit 22 obtains a value indicating the communication quality of each eigenpath. The transmission weight determination unit 23 determines (selects) a transmission weight, among the transmission weights generated by the transmission weight generation unit 21, such that the difference in the values indicating the communication qualities of the eigenpaths obtained by the communication quality obtain unit 22 is equal to or less than a predetermined value and the sum of all of the communication qualities of the plurality of eigenpaths is maximized.

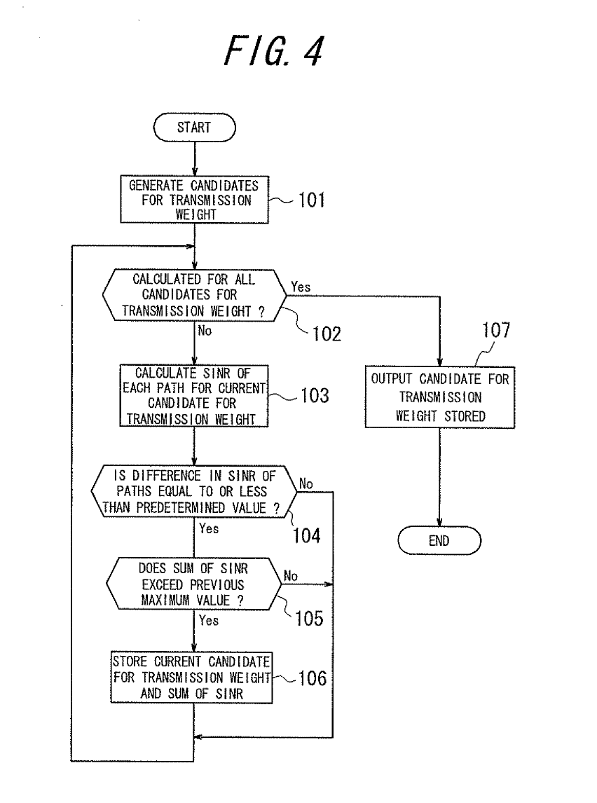

Next, an operation of the present invention is described based on a flowchart shown in FIG. 4. First, the transmission weight generation unit 21 generates candidates for the transmission weight (step 101). Next, the communication quality obtain unit 22 determines whether calculation of SINR of the eigenpaths for all of the candidates for the transmission weight is finished (step 102). If calculation is not finished (if No), SINR of each eigenpath for a current candidate for the transmission weight is calculated (step 103). Then, the transmission weight determination unit 23 determines whether the difference in SINR between the eigenpaths is equal to or less than the predetermined value (step 104). Specifically, the transmission weight determination unit 23 determines whether the difference in SINR between eigenpaths satisfies the following formula:

10 log(SINR_{MAX}−SINR_{MIN})≦8 [dB] [Formula 7]

If the difference in SINR satisfies this formula (if Yes), the transmission weight determination unit 23 determines whether a sum of SINR of the eigenpaths exceeds a maximum value of a sum of SINR previously calculated (step 105). If exceeding (if Yes), a current candidate for the transmission weight and the sum of SINR are stored (step 106). If the difference in SINR is over the predetermined value (if No) at step 104 and if the sum of SINR does not exceed the maximum value (if No), the communication quality obtain unit 22 once again determines whether calculation of SINR of the eigenpaths for all candidates for the transmission weight is finished (step 102). If calculation is finished for all candidates for the transmission weight (if Yes), the transmission weight determination unit 23 outputs the candidate for the transmission weight stored (step 107).

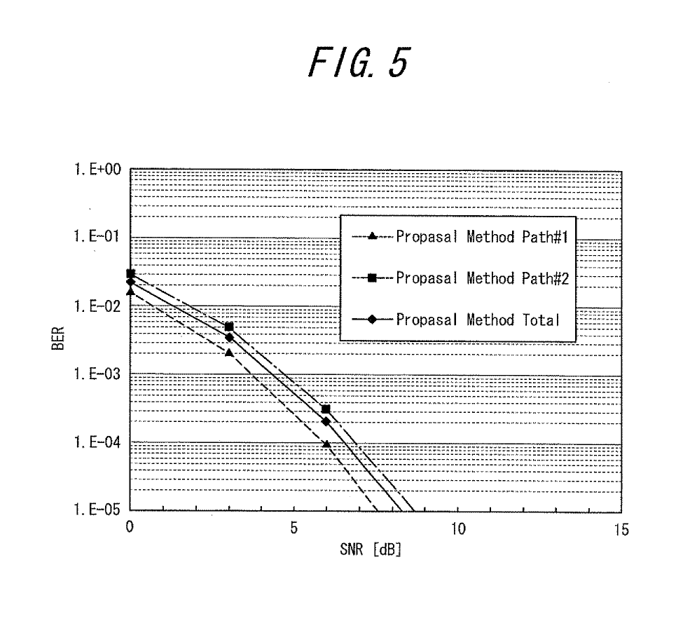

FIG. 5 shows BER (Bit Error Rate) characteristics and overall BER characteristics when the wireless communication system according to the present invention employs a transmission weight such that the difference in the values indicating the communication qualities of the paths is equal to or less than the predetermined value and the sum of all of the communication qualities of the plurality of paths is maximized. FIG. 5 shows BER to SNR with 4 transmission antennas, 4 reception antennas, 2 eigenpaths, QPSK (primary modulation) and 5 GHz (transmission frequency).

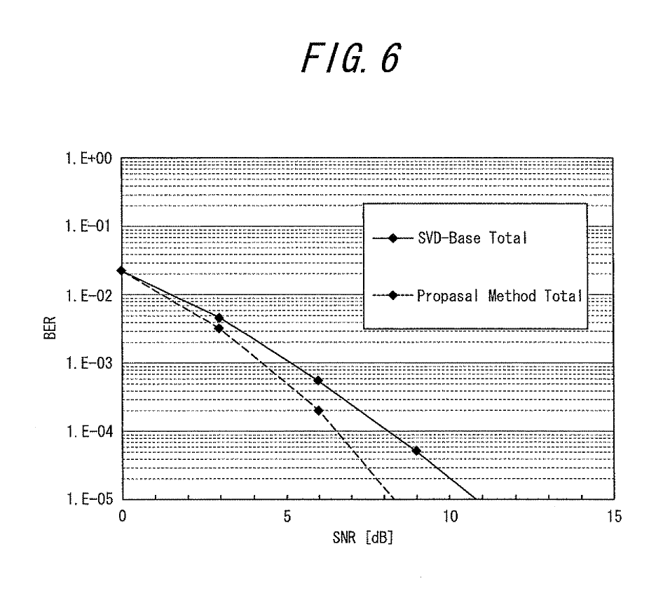

In addition, FIG. 6 shows a comparison of the overall BER characteristics when using the transmission weight selected by the conventional system and when using the transmission weight selected by the wireless communication system according to the present invention. FIG. 6 shows that the wireless communication system according to the present invention achieves low BER characteristics with less SNR.

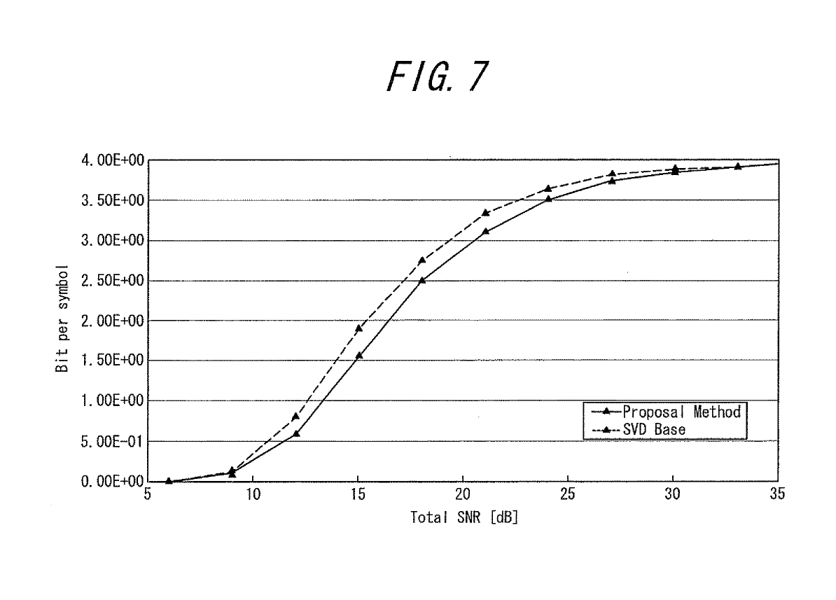

FIG. 7 shows the number of bits which can be transmitted per symbol, as an index similar to frequency usage efficiency. Efficiency of the method selecting the transmission weight of the wireless communication system according to the present invention is shown in the figure, too.

In the above embodiments, SINR is used as the communication quality and, as a condition to select the transmission weight, the transmission weight is determined (selected) such that the difference in values indicating the communication qualities of the eigenpaths is equal to or less than a predetermined value and a sum of all of the communication qualities of the plurality of paths is maximized. However, when the propagation path varies or an estimation error is recognized, another index such as SNR (Signal to Noise Ratio) or SIR (Signal to Interference Ratio) may be used as the communication quality, and the transmission weight may be selected by using different conditions.

Moreover, although it is assumed to use the same modulation scheme for all eigenpaths in the above embodiment, the present invention is also applicable when the same modulation scheme is used for a plurality of eigenpaths.

1. A wireless communication system for performing wireless communication via a plurality of paths between a transmission apparatus and a reception apparatus, comprising:
a transmission weight generation unit for generating a plurality of transmission weights;
a communication quality obtain unit for obtaining a value indicating communication quality of each of the paths; and
a transmission weight determination unit for selecting a transmission weight, among the transmission weights generated by the transmission weight generation unit, such that difference in the values indicating the communication qualities of the paths obtained by the communication quality obtain unit is equal to or less than a predetermined value and a sum of all communication qualities of the plurality of paths is maximized.

2. The wireless communication system according to claim 1, wherein selecting the transmission weight is performed when the transmission apparatus transmits a single packet by dividing it into the plurality of paths.

3. The wireless communication system according to claim 2, wherein the packet is a packet passed through modulation and coding process.

4. A transmission apparatus for performing wireless communication via a plurality of paths,
the transmission apparatus applying a transmission weight such that difference in values indicating communication qualities of the paths is equal to or less than a predetermined value and a sum of all communication qualities of the plurality of paths is maximized, when performing transmission via the plurality of paths.

5. A communication control method of a wireless communication system for performing wireless communication via a plurality of paths between a transmission apparatus and a reception apparatus, comprising the steps of:
generating a plurality of transmission weights;
obtaining a value indicating communication quality of each of the paths; and
selecting a transmission weight, among the transmission weights generated, such that difference in the values indicating the communication qualities of the paths is equal to or less than a predetermined value and a sum of all communication qualities of the plurality of paths is maximized.
